(19) United States
(12) Patent Application Publication
(10) Pub. No.: US 2008/0184836 A1
(43) Pub. Date: Aug. 7, 2008

(54) Haptic Interface With Cables

(76) Inventor: Alain Riwan, Chevilly Larve (FR)

Correspondence Address: ANDERSON, KILL & OLICK, P.C., 1251 AVENUE OF THE AMERICAS, NEW YORK,, NY, 10020-1182, US

(21) Appl. No.: 11/791,914

(22) PCT Filed: Nov. 30, 2005
(86) PCT No.: PCT/FR2005/051009

§ 371 Date: May 30, 2007

(30) Foreign Application Priority Data
Dec. 3, 2004 (FR) 0452861

(51) Int. Cl. G05G 9/047

(52) U.S. Cl. 74/471 XY

(57) ABSTRACT

The haptic interface comprises a base (2), a platform (24) at a distance from the base (2), at least two cables (32) each with a first end fixed to the platform and a second end connected to a puller actuator (36) designed to apply tension on the cable (32). Thrust means are mounted on the base (2) by means of an articulation (50). They comprise a thrust rod (40) with a first end in contact with the platform (24) and a second end connected to a pusher actuator that pushes the thrust rod (40) towards the platform (24). The actuators (36, 44) apply forces to the platform representative of information about a system. The platform comprises a control device.

### TECHNICAL FIELD

The invention relates to control interfaces for a real or virtual system that provide information feedback, for example information representative of a resistance force encountered by the system (force return) or other information related to this system. An interface of this type is called a haptic interface.

More precisely, the invention relates to an interface to control a haptic system comprising a base, a platform at a distance from the base, at least two cables with a first end fixed to the platform and a second end connected to a puller actuator designed to apply tension on the cable, thrust means mounted on the base by means of an articulation and comprising a thrust rod with a first end in contact with the platform and a second end connected to a pusher actuator that pushes the thrust rod towards the platform, the actuators applying forces to the platform, representative of information about the system.

Platforms located between two bases, to which they are connected by cables, are known. These platforms are remarkable for their simplicity, which means that their cost can be reduced, their very low inertia and low friction on cables that provide them with a high pass band.

However, their controllable work space, in other words the volume in which an arbitrary force vector can be applied on the platform, is limited to the polyhedral volume passing through the attachment points of the cables on the two bases. This is the direct consequence of the need to have a strictly positive force in the cables. Subsequently, cable attachment points are distributed onto a sphere surrounding the platform so as to optimise the movement distance, and this does not leave much space for the operator's hand.

A haptic interface is also disclosed (FR 93 13248) that comprises an active part forming a handle that an operator grips in one hand and onto which a movement sensor is fitted for control of a system with one or several information feedback parts installed on the active part and free to move with respect to it. Thus, the operator receives information feedback in part of his hand.

Such a system does not use the principle of Stewart's platform. Cable actuators used to transmit information feedback to the platform are not used to control the system. On the other hand, a distinct movement sensor is used. The movement distance of the platform is very small considering the small dimensions of the handle. Furthermore, the actuators of the platform cables are not fitted on the fixed part, forming a base, but on a remote support connected to the handle by cables sliding in sheaths. The result is unacceptable friction forces, considering the small forces involved.

A manipulator is also disclosed (in U.S. Pat. No. 4,666,362) that comprises a base and a platform at a distance from the base designed for the attachment of a tool or a similar device. Cables connect the base to the platform. A central post resists the tension force applied on the cables by motors installed on the base.

Such a device does not form a haptic interface. It cannot be used to control a system, nor to receive information returned from this system. Forces to be transmitted in an application of this type are higher than in a haptic interface. Therefore, the cable transmission technique is not suitable.

The purpose of the invention is an active interface that overcomes disadvantages according to prior art. It must be capable of increasing the controllable work space of conventional type cable platforms and input of the platform by the operator without interference with the cables. It must also enable a simple production so that it can be manufactured at low cost. Finally, it must be capable of optimising movement distance in rotation.

These objectives are achieved by the fact that the platform comprises a control device.

The interface for the invention maintains the advantages of simplicity and low inertia, and consequently the large passband of Stewart's platforms. Actuators, including actuators that pull cables and actuator that push thrust rods, transmit both the control signal to the system and information feedback from this system. Furthermore, due to the presence of a thrust rod, the controllable work space is extended beyond the cable attachment points on the base.

In one preferred embodiment, each actuator comprises a sensor capable of outputting a signal representing the cable length attached to the sensor and the thrust means comprise a sensor capable of outputting a signal representing the distance between the end of the thrust rod in contact with the platform and their articulation onto the base, all of these signals being used to control the system.

In one particular embodiment, the pusher actuator is composed of a puller actuator that applies tension on a cable and a movement inversion mechanism that transforms the cable tension into a thrust force on the thrust rod.

Due to this characteristic, the same technology can be used for all actuators, including cable actuators and thrust rod actuators. Furthermore, cable actuators assure low cost and low inertia of the transmission system.

Advantageously, the movement inversion mechanism comprises a muffle.

The muffle can reduce the required torque from the thrust rod actuator.

In one embodiment, the movement inversion mechanisms is housed in a jack.

The actuator of the thrust rod can be mounted on this jack or it may be fitted on the base.

In one particular embodiment, the actuator of the thrust rod is placed below the articulation of the thrust means.

This arrangement enables static balancing of thrust means by a distribution of masses on each side of the articulation.

Advantageously, the thrust means are articulated on the platform through a universal joint.

Preferably, the thrust rod is provided with a longitudinal axis that is approximately concurrent with the centre of the universal joint.

Also preferably, the end of the thrust rod is in contact with the platform and articulated on it through a ball joint.

The platform is advantageously made such that its centre is coincident with the centre of the ball joint such that the operator's grip is at the centre of the ball joint.

This characteristic enables a pure rotation movement that minimizes cable movements and increases the working space.

The interface according to the invention may have six degrees of freedom. In this case, it comprises six cables that are advantageously distributed in three pairs of cables fixed in pairs at the ends of a triangle on the platform.

Other characteristics and advantages of the invention will become clear after reading the following description of example embodiments given for illustrative purposes with reference to the appended figures:

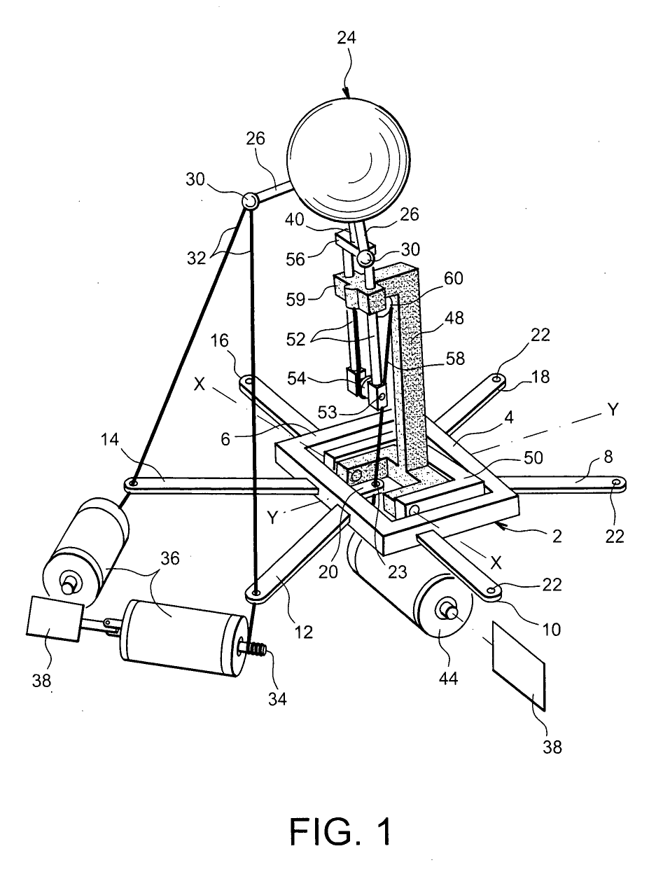

FIG. 1 is a perspective view of a haptic interface conforming with this invention;

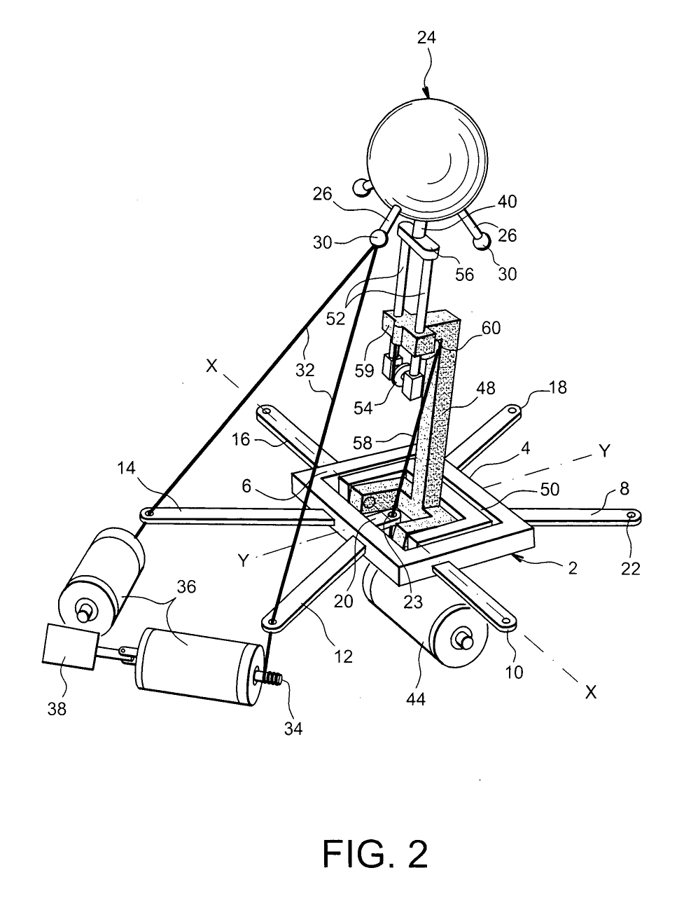

FIG. 2 is a perspective view similar to FIG. 1, the interface being shown in a different position.

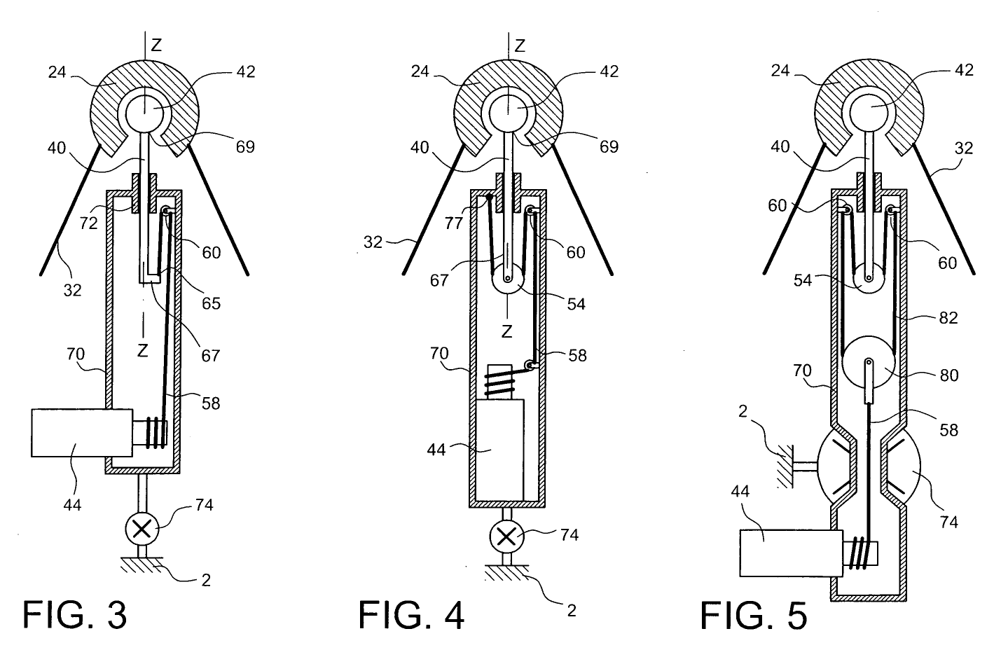

FIGS. 3 to 6 illustrate four different variant embodiments of thrust means;

FIG. 7 is a diagrammatic sectional figure of an embodiment of thrust means comprising springs on cables.

The haptic interface represented in FIGS. 1 and 2 comprises a base denoted by the general reference 2. The base is composed of a rectangular shaped frame comprising two large sides 4 and two small sides 6. Horizontal arms referenced 8, 10, 12, 14, 16 and 18 are fixed to the rectangular frame. Each of these arms is drilled with a through orifice 22 forming a cable guide. An arm 20 also fixed to one of the large sides 4, shorter than the other six arms, also projects towards the inside of the frame. A through orifice 23 forming a cable guide is drilled in it.

The interface comprises a platform 24. In the particular example shown, the platform 24 is in the shape of a sphere, but obviously this embodiment is not compulsory and other shapes would also be feasible. Rods 26 are fixed to the sphere 24. Two cables 32 are fixed to the end 30 of each of the rods 26 (only two cables are shown in FIGS. 1 and 2 for simplification reasons). At their other end, the cables 32 pass inside through orifices 22 located at the ends of the arms 8 to 18 and wind onto a pulley 34 of an actuator 36 driven by an electric motor. Each actuator is provided with a sensor shown diagrammatically by the rectangle 38 in FIGS. 1 and 2. The position of the motor so that the cable length can be deduced.

As can be seen in FIGS. 3 to 6, and also in FIG. 7, the sphere 24 is articulated at the end of a thrust rod 40 through a ball joint 42. Furthermore, it is observed that the centre of the ball joint 42 coincides with the centre of the sphere 24. Consequently, rotation of the platform 24 results in a minimum displacement of the end of rods 26 and consequently each of the six cables 32. Therefore the grip of an operator operating the platform 24 is at the centre of the articulation of the platform on the ball joint 42.

At its lower end, opposite the end carrying the ball joint 42, the rigid thrust rod 40 is connected to a pusher actuator, the function of which is to balance the tension force applied by the six puller actuators 36 on the platform 24 through each of the six cables 32.

In general, a Stewart's platform with n degrees of freedom comprises n+1 cables. For example, a platform with six degrees of freedom comprises seven cables. Since the cables can only transmit a tension force, the controllable work space, in other words the volume in which an arbitrary force vector can be generated on the platform, is limited to the polyhedral volume passing through the cable attachment points on the base. The controllable space is offset outside the polyhedron on the side opposite the pusher actuator, by replacing one of the seven cables by a rigid thrust rod 40.

The pusher actuator may be made in many different ways. It may be a hydraulic or pneumatic jack or it may be a ball screw. In the example embodiment shown, it is composed of a puller actuator 44 and a movement inversion mechanism. In FIGS. 1 and 2, the movement inversion mechanism consists of a bracket 48 articulated on the base 2 through a universal joint. The lower end of the bracket pivots about an XX axis with respect to a structure 50 in the form of a large U, itself mounted free to pivot about a YY axis on one of the large sides 4 of the base 2. The XX and YY axes that are perpendicular to each other intersect at the centre of the cable guide orifice 23 of the arm 20. Two parallel sliding rods 52 are mounted free to slide at the upper end of the bracket 48. The two sliding rods 52 are provided with a hinge pin 53 at their lower ends, on which a pulley 54 is mounted. The two rods 52 are connected through a cross piece 56 at their upper ends. A cable 58 is wound at its lower end onto a pulley (not visible in FIGS. 1 and 2) of the actuator 44. The cable 58 passes through the cable guide 23 of the arm 20, and then onto a first pulley 60 mounted in the upper part of the bracket, and then on the second pulley 54 mounted on the hinge pin 53 connecting the two lower ends of the sliding rods 52. Finally, one end of the cable 58 is fixed to the upper part of the bracket 48. The result is thus a muffle that halves the tension force to be applied to the lower end of the cable 58 by the actuator 44 when the cable is wound onto the actuator pulley, the thrust rod 40, fixed to the cross piece 56 moving away from the base 2. The cables 32 extend simultaneously, each of the actuators 36 releasing the necessary cable length.

FIG. 2 shows another position of the haptic interface in FIG. 1. In FIG. 2, the platform 24 was displaced from the position that it occupies on FIG. 1. It can be seen that the U support 50 has pivoted about its articulation axis YY and that also the bracket 48 has pivoted about its articulation axis XX on the support 50. Furthermore, the platform 24 has rotated about its rotation axis ZZ materialised by the thrust rod 40 (see FIG. 3). Finally, the two guide rods 52 have been moved upwards. Consequently, the lengths of the cables 32 connecting the ends 30 of rods 26 to orifices 22 of arms 8, 10, 12, 14, 16 and 18 have varied. For some of these cables, for example the two cables 32 shown in FIGS. 1 and 2, this variation results in an increase in the length. For other cables, the position change of the platform 24 resulted in a reduction of the length. This is the case particularly for the cable 58 driven by the central actuator 44 of the thrust rod 40.

The sensors 38 associated with each of the peripheral actuators 36 and the central actuator 44 record the different variations of the cables and transmit a magnitude representative of these variations to a computer that calculates the new position of the platform 24. This new position controls a real or virtual system. In return, the actuators 36 and the central actuator 44 receive information. This information may be a feedback of a force encountered by the system or another information. This return information is used by actuators 36 so as to apply tension on the cables 32 and 58 so that the operator can feel a sensation representing the force encountered when his or her hand is placed on the platform 24.

Thus, the result is a haptic interface with cables, with a parallel structure, in which the platform 24 forms both the control device and the device through which the information is returned. This interface has a low inertia due to the simplicity of the cable transmission mechanism, which gives it a wide passband. Furthermore, the cable transmission is well adapted to an application of this type in which forces to be transmitted are low.

FIGS. 3 to 6 show different variant embodiments of movement inversion means and fixation of the actuator 44 of the thrust rod 40. In FIG. 3, the movement inversion means are composed simply of a return pulley 60 of the cable 58, the end 65 of which is fixed to the lower part 67 of the thrust rod 40. The upper end 69 of the thrust rod 40 is fixed to a ball joint 42 on which the platform 24 is articulated. As described above, the platform 24 is composed such that the centre of an operator's grip coincides with the centre of the ball joint 42, and in this way the interface minimises displacement of the cables if the platform is rotated with respect to the ball joint 42.

The return pulley 60 is mounted on the inner wall of a cylinder 70 that forms a cable jack. The thrust rod 40 slides on a contact surface 72 of the jack 70. The actuator 44 of the thrust rod is mounted in the lower part of the jack. The lower end of the jack is articulated on the base 2 through a universal joint 74 shown diagrammatically. This universal joint may be manufactured similarly to that described in FIGS. 1 and 2.

In this embodiment, the movement inversion means do not include a muffle. Consequently, the actuator 44 must be sufficiently powerful to balance the tension applied by each of the six other puller actuators 36 to the cables 32 without a reduction factor.

FIG. 4 shows a variant embodiment of the movement inversion means. They include a first pulley 60 mounted on an inner wall of the cylinder 70 and a second pulley 54 mounted on a hinge pin perpendicular to the lower end 67 of the thrust rod 40. The end 77 of the cable 58 is fixed on an upper wall of the jack 70. The actuator 44 is entirely housed inside the cylinder 70. Furthermore, the lower end of the jack 70 is articulated on the base 2 by a universal joint 74 shown diagrammatically, in the same way as for the embodiment in FIG. 3.

In this embodiment that is functionally identical to the embodiment described with reference to FIGS. 1 and 2, the movement inversion means comprise a muffle that reduces the tension force required on the cable 68 by dividing it by a factor of 2. In this way, the power of the actuator 44 may be divided by two. On the other hand, for the same translation displacement of the thrust rod 40, the actuator 44 must wind or unwind a double cable length.

FIG. 5 shows a third variant embodiment of the movement inversion means. They include a large diameter pulley 80 mounted in the jack 70. Two pulleys 60 are fixed on the inner wall of the cylinder 70. A fourth pulley 54 is mounted on the lower end 67 of the thrust rod 40. The cable 58 of the puller actuator 44 is connected to the rotation axis of the large diameter pulley 80. Furthermore, the mechanism comprises a second closed cable 80 that passes on pulleys 80, 60 and 54 one after the other. In this embodiment, the actuator 44 is mounted at the lower end of the jack 70 but it is located below the universal joint 74 through which the jack 70 is articulated on the base 2. Consequently, the actuator 44 does static balancing of the thrust means. In this embodiment, the masses are better balanced on each side of the articulation axis formed by the universal joint 74, the mass of the actuator 44 partly balancing the mass of the remainder of the thrust means.

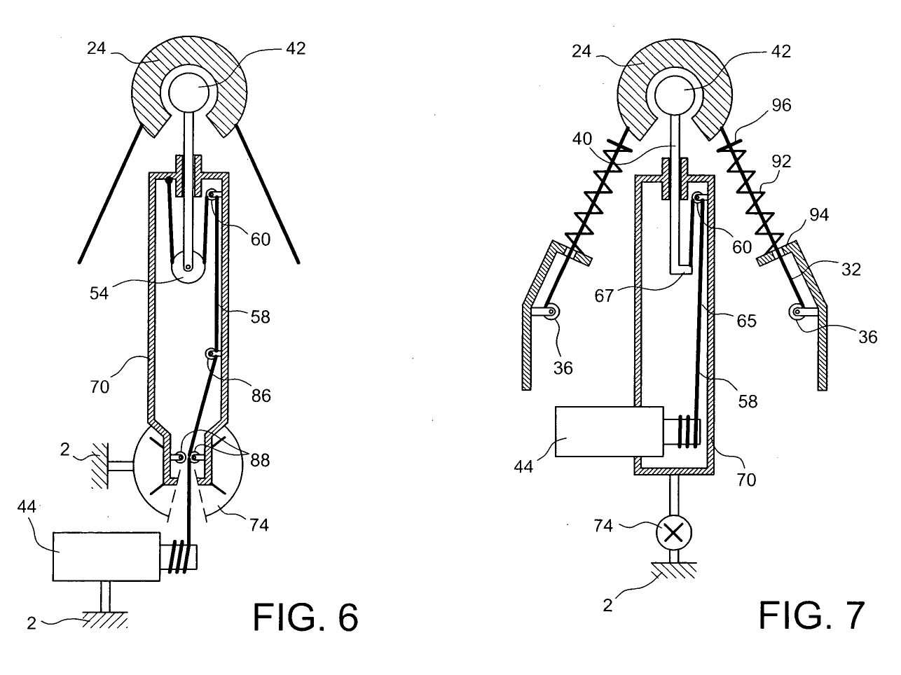

FIG. 6 shows a fourth variant embodiment of the thrust means. In this variant, the actuator 44 is mounted on the base 2 instead of being fixed to the lower part of the jack 70, as in the previous embodiments. The cable 58 of the actuator 44 passes on a pulley 60 fixed to the lower wall of the cylinder 70 and on a pulley 54 mounted on a rotation axis perpendicular to the lower end 67 of the thrust rod 40. The result is thus a muffle comparable to the muffle used for the embodiments in FIGS. 4 and 5, that halves the tension force to be applied on the cable 58. The lower part of the cable 58 is also guided on a guide pulley 86 fixed on the inner wall of the jack, and by two return pulleys 88 located at the lower end of the jack, approximately at the universal joint 74. The lower wall of the jack 70 is open so that the cable can pass through.

Finally, FIG. 7 shows a variant embodiment of the thrust means in FIG. 3. This variant is identical to that in FIG. 3 in all respects, except for the presence of compression springs 92 mounted around the cables 32 of the puller actuators 36. Each helical spring 92 is trapped between a lower thrust surface 94 fixed to the base 2 and an upper thrust surface 96 fixed to the platform 24. The presence of springs 92 balance the tension force applied on the cables 32, and consequently reduces the force imposed to the central actuator 44. It also helps to materialise a central rest position.

1. Haptic interface for the control of a system, comprising a base (2), a platform (24) at a distance from the base (2), at least two cables (32) each with a first end fixed to the platform (24) and a second end connected to a puller actuator (36) designed to apply tension on the cable (32), thrust means mounted on the base (2) by means of an articulation (50, 74) and comprising a thrust rod (40) with a first end (42) in contact with the platform (24) and a second end (67) connected to a pusher actuator that pushes the thrust rod (40) towards the platform (24), the actuators (36, 44) applying forces to the platform (24) representative of information about the system, characterised in that the platform (24) comprises a control device.

2. Interface according to claim 1, characterised in that each actuator (36, 44) comprises a sensor (38) capable of outputting a signal representing the length of the cable (32, 58) attached to the sensor and the thrust means comprise a sensor (38) capable of outputting a signal representing the distance between the end of the thrust rod (40) in contact with the platform (24) and their articulation (50, 74) onto the base (2), all of these signals being used to control the system.

3. Interface according to claim 1, characterised in that the pusher actuator is composed of a puller actuator (44) that applies tension on a cable (58) and a movement inversion mechanism (54, 60) that transforms the cable tension (58) into a thrust force on the thrust rod (40).

4. Interface according to claim 3, characterised in that the movement inversion mechanism comprises a muffle (54, 60).

5. Interface according to one of claim 3, characterised in that the movement inversion mechanism is housed in a jack (70).

6. Interface according to claim 5, characterised in that the actuator (44) of the thrust rod (40) is mounted on the jack (70).

7. Interface according to claim 1, characterised in that the actuator (44) of the thrust rod (40) is mounted on the base (2).

8. Interface according to claim 1, characterised in that the actuator (44) of the thrust rod (40) is placed below the articulation (74) of the thrust means on the base (2).

9. Interface according to claim 1, characterised in that the thrust means are articulated on the platform through a universal joint.

10. Interface according to claim 9, characterised in that the thrust rod (40) is provided with a longitudinal axis (ZZ) that is approximately concurrent with the centre (23) of the universal joint.

11. Interface according to claim 1, characterised in that the end of the thrust rod (40) in contact with the platform is articulated to it through a ball joint (42).

12. Interface according to claim 11, characterised in that the platform (24) is made such that its centre is coincident with the centre of the ball joint such that the operator's grip is at the centre of the ball joint (42).

13. Interface according to claim 1, characterised in that it comprises six cables that are advantageously distributed in three pairs of cables (32) fixed in pairs at the ends (30) of a triangle on the platform (24).

14. Interface according to claim 2, characterised in that the pusher actuator is composed of a puller actuator (44) that applies tension on a cable (58) and a movement inversion mechanism (54, 60) that transforms the cable tension (58) into a thrust force on the thrust rod (40).

15. Interface according to claim 4, characterised in that the movement inversion mechanism is housed in a jack (70).

16. Interface according to claim 2, characterised in that the actuator (44) of the thrust rod (40) is mounted on the base (2)

17. Interface according to claim 3, characterised in that the actuator (44) of the thrust rod (40) is mounted on the base (2)

18. Interface according to claim 4, characterised in that the actuator (44) of the thrust rod (40) is mounted on the base (2)

19. Interface according to claim 5, characterised in that the actuator (44) of the thrust rod (40) is mounted on the base (2)

20. Interface according to claim 2, characterised in that the actuator (44) of the thrust rod (40) is placed below the articulation (74) of the thrust means on the base (2).

21. Interface according to claim 3, characterised in that the actuator (44) of the thrust rod (40) is placed below the articulation (74) of the thrust means on the base (2).

22. Interface according to claim 4, characterised in that the actuator (44) of the thrust rod (40) is placed below the articulation (74) of the thrust means on the base (2).

23. Interface according to claim 5, characterised in that the actuator (44) of the thrust rod (40) is placed below the articulation (74) of the thrust means on the base (2).

24. Interface according to claim 6, characterised in that the actuator (44) of the thrust rod (40) is placed below the articulation (74) of the thrust means on the base (2).

25. Interface according to claim 7, characterised in that the actuator (44) of the thrust rod (40) is placed below the articulation (74) of the thrust means on the base (2).

26. Interface according to claim 2, characterised in that the thrust means are articulated on the platform through a universal joint.

27. Interface according to claim 3, characterised in that the thrust means are articulated on the platform through a universal joint.

28. Interface according to claim 4, characterised in that the thrust means are articulated on the platform through a universal joint.

29. Interface according to claim 5, characterised in that the thrust means are articulated on the platform through a universal joint.

30. Interface according to claim 6, characterised in that the thrust means are articulated on the platform through a universal joint.

31. Interface according to claim 7, characterised in that the thrust means are articulated on the platform through a universal joint.

32. Interface according to claim 8, characterised in that the thrust means are articulated on the platform through a universal joint.

33. Interface according to claim 2, characterised in that the end of the thrust rod (40) in contact with the platform is articulated to it through a ball joint (42).

34. Interface according to claim 3, characterised in that the end of the thrust rod (40) in contact with the platform is articulated to it through a ball joint (42).

35. Interface according to claim 4, characterised in that the end of the thrust rod (40) in contact with the platform is articulated to it through a ball joint (42).

36. Interface according to claim 5, characterised in that the end of the thrust rod (40) in contact with the platform is articulated to it through a ball joint (42).

37. Interface according to claim 6, characterised in that the end of the thrust rod (40) in contact with the platform is articulated to it through a ball joint (42).

38. Interface according to claim 7, characterised in that the end of the thrust rod (40) in contact with the platform is articulated to it through a ball joint (42).

39. Interface according to claim 8, characterised in that the end of the thrust rod (40) in contact with the platform is articulated to it through a ball joint (42).

40. Interface according to claim 9, characterised in that the end of the thrust rod (40) in contact with the platform is articulated to it through a ball joint (42).

41. Interface according to claim 10, characterised in that the end of the thrust rod (40) in contact with the platform is articulated to it through a ball joint (42).

42. Interface according to claim 2, characterised in that it comprises six cables that are advantageously distributed in three pairs of cables (32) fixed in pairs at the ends (30) of a triangle on the platform (24).

43. Interface according to claim 3, characterised in that it comprises six cables that are advantageously distributed in three pairs of cables (32) fixed in pairs at the ends (30) of a triangle on the platform (24).

44. Interface according to claim 4, characterised in that it comprises six cables that are advantageously distributed in three pairs of cables (32) fixed in pairs at the ends (30) of a triangle on the platform (24).

45. Interface according to claim 5, characterised in that it comprises six cables that are advantageously distributed in three pairs of cables (32) fixed in pairs at the ends (30) of a triangle on the platform (24).

46. Interface according to claim 6, characterised in that it comprises six cables that are advantageously distributed in three pairs of cables (32) fixed in pairs at the ends (30) of a triangle on the platform (24).

47. Interface according to claim 7, characterised in that it comprises six cables that are advantageously distributed in three pairs of cables (32) fixed in pairs at the ends (30) of a triangle on the platform (24).

48. Interface according to claim 8, characterised in that it comprises six cables that are advantageously distributed in three pairs of cables (32) fixed in pairs at the ends (30) of a triangle on the platform (24).

49. Interface according to claim 9, characterised in that it comprises six cables that are advantageously distributed in three pairs of cables (32) fixed in pairs at the ends (30) of a triangle on the platform (24).

50. Interface according to claim 10, characterised in that it comprises six cables that are advantageously distributed in three pairs of cables (32) fixed in pairs at the ends (30) of a triangle on the platform (24).

51. Interface according to claim 11, characterised in that it comprises six cables that are advantageously distributed in three pairs of cables (32) fixed in pairs at the ends (30) of a triangle on the platform (24).

52. Interface according to claim 12, characterised in that it comprises six cables that are advantageously distributed in three pairs of cables (32) fixed in pairs at the ends (30) of a triangle on the platform (24).
